(19) United States
(12) Patent Application Publication
(10) Pub. No.: US 2009/0251907 A1
(43) Pub. Date: Oct. 8, 2009

(54) Reflector lamp filter adapter

(76) Inventor: Jack V. Miller, Seaford, DE (US)

Correspondence Address: Jack V. Miller, 20915 Sussex Hwy., Seaford, DE, 19973, US

(21) Appl. No.: 11/986,653

(22) Filed: Nov. 26, 2007

(51) Int. Cl. F21V 17/02

(52) U.S. Cl. 362/433

(57) ABSTRACT

A reflector lamp filter adapter according to the present invention comprises a generally U-shaped resilient bracket having a base and 2 parallel sides wherein the base and sides have slots adapted to receive and hold the rim of a reflector lamp emitting visible light, IR (infrared heat) and UV (ultraviolet) energy; a heat-reflecting, light-transmitting hot mirror; a heat-absorbing filter; and in one preferred embodiment, a UV-blocking filter. The U-shaped bracket has a lock engaging the distal edges of the sides of the U, securely locking the lamp reflector and filters therein. The bracket includes convection cooling apertures so the final light beam is only visible light, with no ultraviolet of infrared energy.

### US PATENTS REFERENCES CITED

U.S. Pat. No. 5,099,399—Miller, et al.

U.S. Pat. No. 6,409,534—Miller, et al.

U.S. Pat. No. 5,967,653—Miller, et al.

U.S. Pat. No. 7,223,022—Miller, et al.

### FIELD OF THE INVENTION

The present invention relates to the field of reflector lamps, and more specifically to incandescent parabolic reflector lamps known as MR-16 lamps commonly used in tracklight and small downlight fixtures, and to reflector lamps known as PAR lamps commonly used in recessed downlight fixtures in residential, institutional and commercial buildings.

### BACKGROUND OF THE INVENTION

Parabolic reflector lamps are the most popular lamps used in general lighting for commercial buildings. They are usually identified in the lighting industry as “PAR” lamps, in which a light source, such as an incandescent filament is oriented at the focal point of a parabolic reflector to produce a substantially collimated (parallel) light beam. Such PAR lamps employ integral screw bases that are supported within lamp sockets connected to remote sources of electrical power.

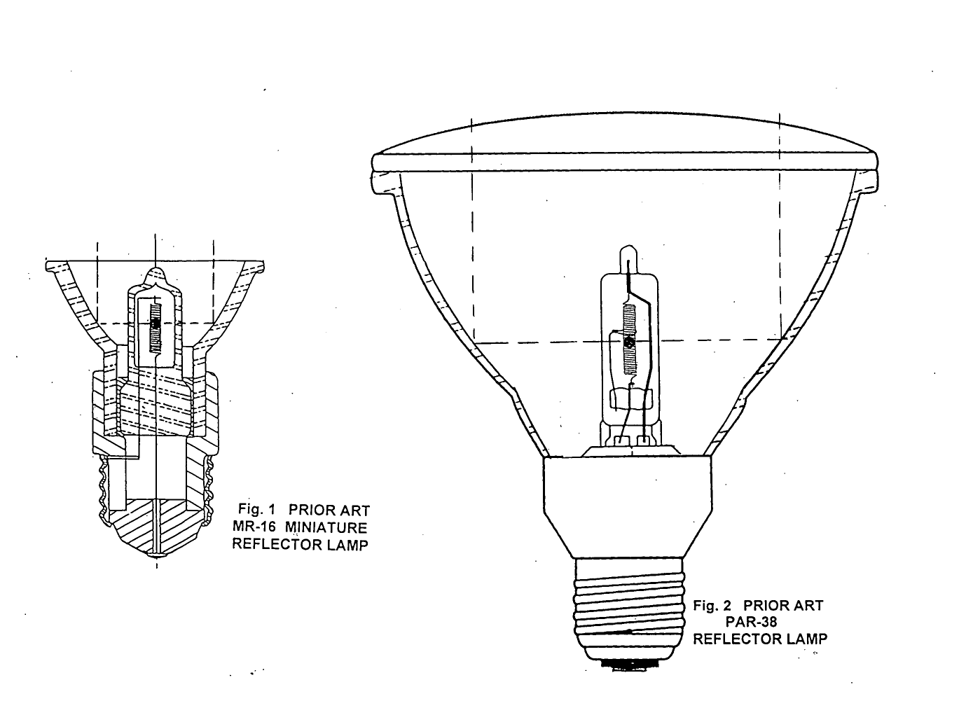

The reflectors of PAR lamps are normally classified by reflector rim diameter, such as MR-16 (Miniature Reflector, 16 ⅛ths of an inch, or 2-inches in diameter) as shown in Prior art FIG. 1, up through PAR 38 lamps (38 ⅛ths of an inch, or 4¾-inches in diameter), as shown in Prior art FIG. 2.

Over recent years parlamps have grown in popularity in commercial buildings, compared to fluorescent lamps, because their incandescent filament light sources are small enough to be sharply focused. The MR-16 lamp is widely used because it can be made in a 10° or 20° spotlight that fits into small downlights and tracklights. A tungsten-halogen MR-16 lamp is shown approximately full size in FIG. 1. A larger PAR 38 prior art reflector lamp is the is also shown approximately full size in FIG. 2.

One advantage an incandescent lamp has over compact fluorescent lamps is the incandescent lamp has a continuous, uninterrupted SPD (Spectral Power Distribution) with no gaps in its spectral output throughout the visible spectrum from UV (ultraviolet) shorter than at 380 nm (nanometers) wavelength, to IR (infrared) longer than 770 nm wavelength. The uninterrupted SPD provides excellent color rendition, but the visible light from an incandescent lamp is only about 10% of the lamp energy, with the remaining 90% being about 5% UV and 85% IR heat.

The UV and IR energy are invisible radiations that do not contribute to vision, but only contribute to fading and photochemical damage to textiles, rugs and even groceries on display in stores.

Even though UV and IR are invisible to the humans, the eyes do sense UV and IR, producing a pupillary response that constricts the iris to a small diameter to protect the retina from invisible light damage. Reducing the iris diameter reduces the amount of light received by the retina, thereby reducing visual efficiency.

Experiments by the applicant have shown visual efficiency to be reduced by approximately 50% by the pupillary response to UV and IR in tungsten halogen lamps. Therefore, without reducing vision, light levels (and energy consumption) can be literally cut in half when the UV and IR are removed from the illumination.

The applicant's cited prior art patents, some dating back 15 years, disclose several ways to make light fixtures with no UV or IR, but at considerable expense. The cost has been justified in museum applications where light damage is critical for preserving their collections. However, when energy costs at that time were only $0.05 per kilowatt hour, and it was not cost effective to use the more expensive museum quality light fixtures in commercial buildings. Now that energy costs have escalated to $0.15 per kilowatt hour and still climbing, the ROI (return on investment) for fixtures with no UV or IR is only 2 years, which is considered a good business practice. And an even better ROI can be achieved with a light source that can replace ordinary incandescent lamps without replacing the entire fixture.

The present invention provides a reflector lamp filter adapter as an inexpensive way to eliminate the UV and IR from the beams of existing lamps currently used in commercial buildings. This achieves the major advantages of using light with no UV:

1) Elimination of the UV/IR pupillary response, maintaining good visibility with reduced light levels and lower energy use.

2) Removing UV and IR reduce the skin temperature of occupants, lowering comfortable thermostat settings, and thereby reducing air conditioning loads.

3) Radiant UV and IR in emitted light is absorbed by room thermostats. This raises the apparent temperature seen by air thermostats, so removing UV and IR provides more accurate room air temperature sensing, again, using less air conditioning power.

### DETAILED DESCRIPTION OF THE PRESENT INVENTION DRAWINGS

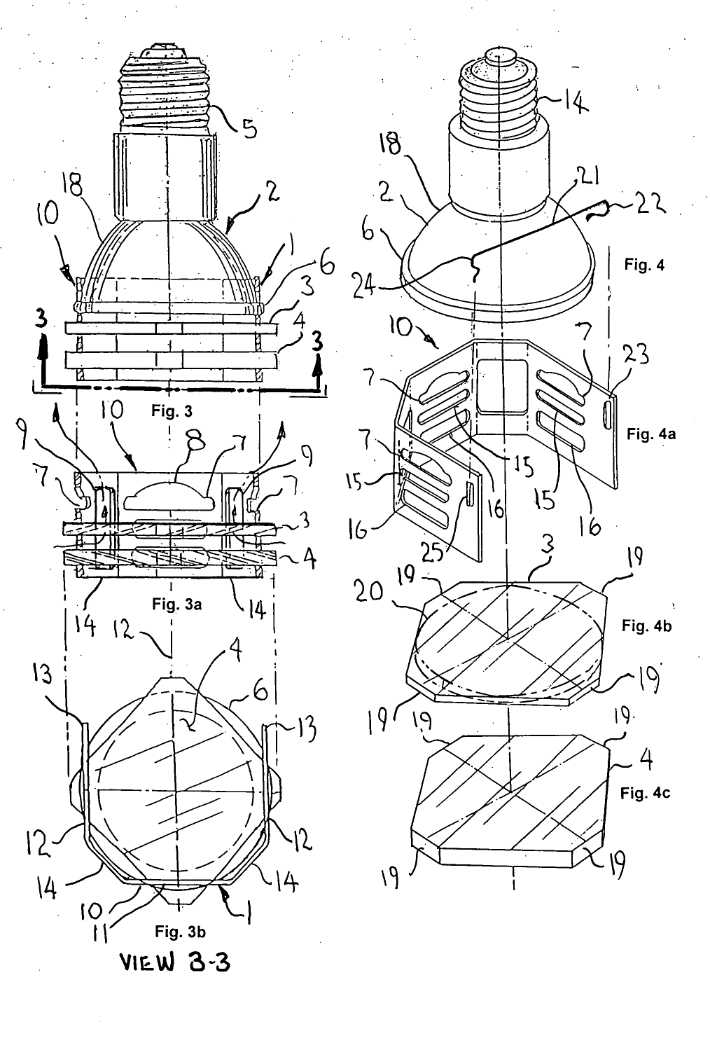

FIG. 3 shows a side elevation view of a reflector lamp filter adapter (1) according to the present invention, attached to a parabolic reflector lamp (2) that emits a beam including visible light, infrared and ultraviolet energy, said lamp having an exterior reflector surface. A first preferred embodiment of the invention is a filter adapter (1) is shown as a bracket (10) holding the reflector rim (6) of lamp (2), an infrared-reflecting, visible-light-transmitting “hot” mirror (3) that reflects heat back into the lamp, and a heat-absorbing glass filter (4) that dissipates absorbed heat in the lamp beam by diffuse radiation and convection. A second preferred embodiment of the invention includes an ultraviolet blocking final filter.

In FIG. 3a a cross-sectional view of filter adapter (1) is shown having lamp retaining slots 7 in a bracket (10) each slot (7) including a radius (8) that clears the reflector surface (18) of lamp (2) to firmly hold lamp reflector rim (6). Hot mirror (3) and heat-absorbing filter (4) are held in a spaced relationship permitting cooling air to flow across their glass surfaces and convect through vertical slots (9) in corners (14).

FIG. 3b is View 3-3 of FIG. 3, showing filter adapter (1) including an elongated, generally U-shaped resilient bracket (10) comprising a base (11) and 2 parallel orthogonal sides (12) equidistant from the optical axis (13) of reflector lamp (2), said sides each having parallel edges (13) and 45° corners (14) of bracket (10).

In FIG. 4 a typical reflector lamp (2) is shown having a screw base (14), a parabolic reflector (18) and rim (6).

In FIG. 4a filter adapter (1) is shown having a first set of 3 slots (7) in a common transverse plane in the base (11) and each side (12) of bracket (10), said slots being adjacent to the proximal end of the bracket and being configured to receive and hold rim (6) of parabolic reflector lamp (2).

A second set of 3 slots (15) in a common transverse plane of bracket (10), are spaced in the distal direction from the first set of slots (7), said second set of slots (15) configured to receive and hold the edges of light-transmitting, infrared-reflecting mirror (3).

A third set of 3 slots (16) in a common transverse plane in the base (11) and each side of base (11) of bracket (10), said slots being spaced in the distal direction from the second set of slots and configured to receive and hold the edges of light-transmitting, heat-absorbing filter (4).

In FIG. 4b a preferred configuration for a hot mirror (3) is shown to be generally square, the least expensive glass cutting pattern. The corners (19) may optionally ground, also an inexpensive process, to provide a smaller overall size. The smallest overall size may be obtained by cutting the filters into circles (20), which although more costly, may be preferred in some applications.

In FIG. 4c a heat-absorbing filter (4) is shown is shown having the same perimeter configuration as the hot mirror of FIG. 4b.

Returning to FIGS. 4 and 4a, a lock (21) is provided with a hinge loop (22) that engages and pivots in aperture (23) and a latch (24) that snaps into aperture (25), thus locking lamp reflector rim (6), hot mirror (3) and heat-absorbing filter (4) securely in place.

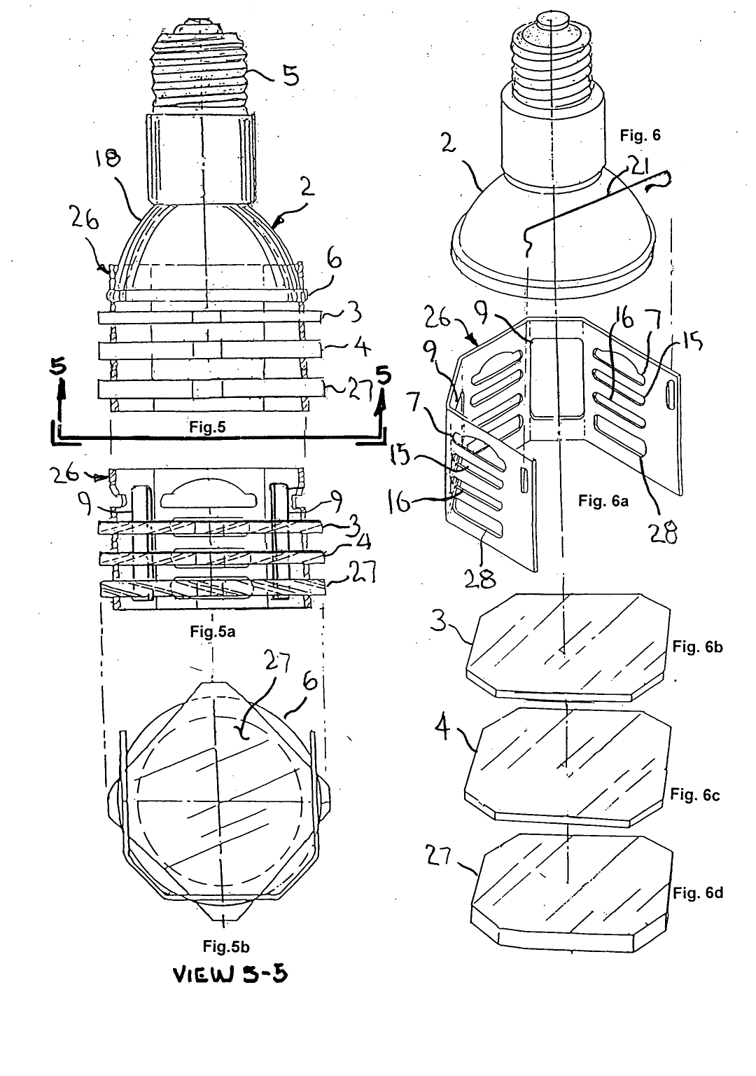

In FIGS. 5 and 5a the same reflector lamp (2) from FIG. 3 is shown having a screw base (5), a parabolic reflector (18) and rim (6) which are retained within a filter adapter (26) holding the lamp reflector rim (6), hot mirror (3) and heat-absorbing lens (4) as shown in FIG. 3, and holding an added ultraviolet-absorbing filter (27).

In FIG. 5b the same preferred configuration as FIG. 3b is shown, but in VIEW 5-5 ultraviolet-absorbing filter (27) is visible.

In FIG. 6 and 6a filter adapter (26) is shown having a first set of 3 slots (7), a second set of 3 slots (15) and a third set of 3 slots (16) as shown in FIG. 3a, and an additional set of 3 slots (28).

In FIGS. 6b and 6c the hot mirror (3) and heat-absorbing filter (4) are shown from FIGS. 4b and 4c. Hot mirror (3) and heat-absorbing filter (4) are both made of glass, which is transparent to ultraviolet light, that should be blocked for many applications, such as illuminating textiles, rugs and other organic materials, such as paper.

In FIG. 6d the ultraviolet filter 27 is shown, which is made of a polymeric material that is opaque to UV, such as visibly transparent acrylic, polycarbonate or polyvinyl plastics.

Lock (21) as shown in FIG. 4 is also included in FIG. 6 to lock lamp reflector rim (6), hot mirror (3) and heat-absorbing filter (4) and ultraviolet filter 27 securely in place.

The reflector lamp filter adapter of the present invention, as shown in the drawings and described in this specification makes it possible to remove the IR heat and damaging UV radiation from the beams of reflector lamps of any size or light source, such as tungsten-halogen or gas discharge lamps.

1. A filter adapter for a parabolic reflector lamp including:
an elongated, generally U-shaped resilient bracket comprising a base and 2 parallel orthogonal sides equidistant from the optical axis of a reflector lamp, said sides having a parallel edges;
a first set of 3 slots in a common transverse plane in the base and each side of the bracket, said slots being adjacent to the proximal end of the bracket and being configured to receive and hold the rim of the reflector of a parabolic reflector lamp;
a second set of 3 slots in a common transverse plane in the base and each side of the bracket, said slots being spaced in the distal direction from the first set of slots and configured to receive and hold the edges of a light-transmitting, infrared-reflecting mirror; and
a third set of 3 slots in a common transverse plane in the base and each side of the bracket, said slots being spaced in the distal direction from the second set of slots and configured to receive and hold the edges of a light-transmitting, heat-absorbing filter.

2. A reflector lamp filter adapter according to claim 1 in which the first set of slots include a radius conforming to the exterior curvature of the parabolic reflector of the lamp.

3. A reflector lamp filter adapter according to claim 1 in which the parallel edges of the sides of the U-shaped bracket are connected by a lock securing the lamp reflector rim, the light-transmitting, infrared-reflecting mirror and the light-transmitting, heat-absorbing filter into the bracket.

4. A reflector lamp filter adapter according to claim 1 in which the U-shaped bracket and parallel orthogonal sides include convection cooling apertures.

5. A reflector lamp filter adapter according to claim 1 in which the light-transmitting, infrared-reflecting mirror and the light-transmitting, heat-absorbing filter are round.

6. A reflector lamp filter adapter according to claim 1 in which the light-transmitting, infrared-reflecting mirror and the light-transmitting, heat-absorbing filter are substantially square.

7. A filter adapter for a parabolic reflector lamp including:
an elongated, generally U-shaped resilient bracket comprising a base and 2 parallel orthogonal sides equidistant from the optical axis of a reflector lamp, said sides having a parallel edges;
a first set of 3 slots in a common transverse plane in the base and each side of the bracket, said slots being adjacent to the proximal end of the bracket and being configured to receive and hold the rim of the reflector of a parabolic reflector lamp;
a second set of 3 slots in a common transverse plane in the base and each side of the bracket, said slots being spaced in the distal direction from the first set of slots and configured to receive and hold the edges of a light-transmitting, infrared-reflecting mirror; and
a third set of 3 slots in a common transverse plane in the base and each side of the bracket, said slots being spaced in the distal direction from the second set of slots and configured to receive and hold the edges of a light-transmitting, heat-absorbing filter.
a fourth set of 3 slots in a common transverse plane in the base and each side of the bracket, said slots being spaced in the distal direction from the third set of slots and configured to receive and hold the edges of an ultraviolet-blocking filter.

8. A reflector lamp filter adapter according to claim 7 in which the first set of slots include a radius conforming to the exterior curvature of the parabolic reflector of the lamp.

9. A reflector lamp filter adapter according to claim 7 in which the parallel edges of the sides of the U-shaped bracket are connected by a lock securing the lamp reflector rim, the light-transmitting, infrared-reflecting mirror and the light-transmitting, heat-absorbing filter into the bracket.

10. A reflector lamp filter adapter according to claim 7 in which the U-shaped bracket and parallel orthogonal sides include convection cooling apertures.

11. A reflector lamp filter adapter according to claim 7 in which the light-transmitting, infrared-reflecting mirror and the light-transmitting, heat-absorbing filter are round.

12. A reflector lamp filter adapter according to claim 7 in which the light-transmitting, infrared-reflecting mirror and the light-transmitting, heat-absorbing filter are substantially square.
